(19) United States
(12) Patent Application Publication
(10) Pub. No.: US 2009/0240763 A1
(43) Pub. Date: Sep. 24, 2009

(54) MESSAGING DEVICE AND SYSTEM

(76) Inventors: William G. Hones, SeaTac, WA (US); Manh Hoang, Kent, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/054,265

(22) Filed: Mar. 24, 2008

(51) Int. Cl. G06F 15/16

(52) U.S. Cl. 709/203; 709/206

(57) ABSTRACT

A display device configured to use an array of discrete light sources to display information received from a remote computer over a network. The device includes a processor coupled to the light sources and a memory storing computer-executable instructions and a device identifier. The device is coupled to the network by a network interface configured to send a request including the device identifier periodically to the remote computer. The remote computer is configured to receive messages from other remote computers for display by the display device. In response to each request, the remote computer uses the device identifier to identify messages for the display device stored in a device account, which are subsequently downloaded by the display device for display thereby. The processor is operable to turn selected ones of the discrete light sources on and off to display information in the downloaded message.

### BACKGROUND OF THE INVENTION

1. Field of the Invention

The present invention is directed generally to messaging systems and display devices configured to display information contained in messages received from a remote user over a network.

2. Description of the Related Art

According to the theory of persistence of vision, the perceptual processes of the retina of the human eye retain an image for a brief moment. Persistence of vision is believed to cause the perception of motion when viewing a series of film images displayed in quick succession, instead of the perception of a series of discrete images. Persistence of vision also causes many flashing light sources (such as fluorescent light bulbs) to appear as continuous light sources.

Persistence of vision has been recognized for over 350 years. Today, it is understood that when light strikes the retina, photosensitive chemicals present in the retina detect, process, and transmit a neural signal to the brain. The retained persistent image is caused at least in part by an amount of time required for the production and decay of those photosensitive chemicals.

The phenomenon of persistence of vision is used by several devices, including popular toys, household appliances, and the like to display information. Examples of devices that use persistence of vision to display information (“persistence of vision displays”) include a XP3 clock manufactured by Fascinations Toys and Gifts of Seattle, Wash. The XP3 clock has a one-dimensional array of eight light emitting diodes (“LEDs”) arranged along the outside surface of a wand near its tip. The wand is oscillated at a rate of 16 oscillations per second and each LED remains lit for only 0.185 milliseconds. The XP3 clock includes a processor coupled to a memory configured to store computer-readable instructions for instructing the processor when to turn selected LEDs on and off as the wand oscillates for the purposes of displaying a message. The XP3 clock may be programmed locally using an on-board user interface to display short messages (e.g., up to 12 characters). However, the XP3 clock, like many other prior art persistence of vision displays, is a stand-alone device that must be programmed locally by its owner. As a result, a message cannot be sent to a persistence of vision display over a network, such as the Internet.

Information sent over networks, such as the Internet, is typically displayed using a two-dimension display device, such as a computer monitor, personal data assistance screen, pager display, cellular telephone screen, and the like. However, such displays are commonplace and not well suited to attracting the user's attention. On the other hand, persistence of vision displays are eye catching by their very nature and draw attention based on the novelty of the display mechanism and the seeming impossibility of the message display means.

Further, many devices that display information received from a remote user over a network (e.g., the internet, a cellular network, and the like) require the user to configure the device or an account before the user can receive and display messages. Configuring such devices for use wastes the user's time and can be intimidating to some users. Users are sometimes frustrated by lengthy or complicated configuration processes. Additionally, users are often frustrated by unclear configuration instructions or processes that require the input of configuration parameters that are unknown to the user or are not easily obtained by the user. Further, if the device is moved to a different location in the network, the user may need to repeat the configuration process. In addition to configuring the device, users are typically required to configure a message account used to store and send messages to the device for display. For example, if a user wishes to receive email messages on his/her computer, the user typically sets up an email account, including picking an email address, with a provider of email services. This process typically includes contacting the service provider.

Presently, a need exists for a device capable of displaying a message sent over a network in a manner that is more likely to attract attention, such as by using a persistence of vision display. A need also exists for a persistence of vision display that can receive messages sent over a network and display them to a user. Additionally, a need exists for a display device capable of receiving messages over a network that does not require configuration by the user. A message account that does not require configuration by the user is also desirable. The present application provides these and other advantages as will be apparent from the following detailed description and accompanying figures.

### BRIEF DESCRIPTION OF THE SEVERAL VIEWS OF THE DRAWING(S)

FIG. 1 is an illustration of a communication system including a display device configured to receive messages over a network.

FIG. 2 is a block diagram of a memory of the display device of FIG. 1.

FIG. 3 is an illustration of an exemplary user interface for the display device of FIG. 1.

FIG. 4 is a block diagram of a network interface of the display device of FIG. 1

FIG. 5 is a diagram of a hardware environment and an operating environment in which a remote computing device and a client computing device of the communication system of FIG. 1 may be implemented.

FIG. 6 is a block diagram of other programming modules stored in a memory of the remote computing device of the communication system of FIG. 1.

FIG. 7 is an interaction diagram illustrating exemplary interacts between the display device, the remote computing device, and the client computing device of the communication system of FIG. 1.

FIG. 8 is a flow diagram illustrating an exemplary method performed by the display device of FIG. 1.

### DETAILED DESCRIPTION OF THE INVENTION

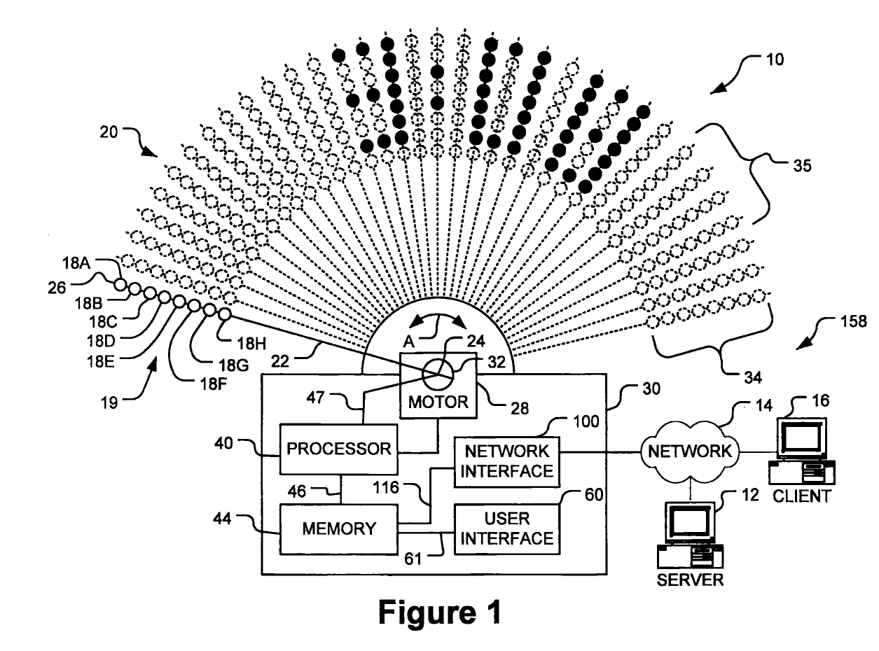

Referring to FIG. 1, aspects of the present invention relate to a display device 10, such as a persistence of vision display, panel of light emitting diodes (“LEDs”), and the like, configured to receive messages from a remote computing device 12 over a network 14 and use those messages to display information to a user. The messages received may include the information to be displayed, a program or instructions instructing the display device 10 to display the information, a combination thereof, and the like. The remote computing device 12 may function as a message server configured to receive messages for the display device 10 from other remote computing devices (e.g., a remote client computing device 16) coupled to the network 14.

In addition to displaying information related to a message received by the display device 10 over the network 14, some embodiments of the display device 10 may be programmed locally by their users. Therefore, the display device 10 will be described as being capable of displaying information related to received messages (i.e., messages received by the display device 10 over the network 14) and local messages (i.e., messages programmed into the display device 10 locally by a user). However, as is apparent to those of ordinary skill in the art, the user may send messages to the display device 10 over the network 14. Therefore, it is not necessary to configure the display device 10 for local programming by the user.

For ease of illustration, the display device 10 is depicted in the drawings and described hereafter is a persistence of vision display. However, those of ordinary skill in the art appreciate that other visual displays may be adapted for use with the present technology. For example, through the application of ordinary skill in the art to the present teachings, a panel of LEDs may be adapted to receive messages from the remote user and display them to the user.

The display device 10 includes an array of one or more discrete light sources 18A-18H, which are selectively illuminated to display a message. In the display device 10 depicted in the drawings, the one or more discrete light sources 18A-18H (e.g., LEDs) are moved quickly enough such that their illumination persists on the retina and appears to an observer as more than the one or more discrete light sources actually present. For example, the discrete light sources 18A-18H may be arranged in a one-dimensional array 19 moving side-to-side quickly enough such that their illumination persists on the retina and appears to an observer as a two-dimensional array 20 of discrete light sources.

By way of example, the one-dimensional array 19 of discrete light sources may be a linear array arranged axially along the outside surface of a wand 22. The wand 22 includes a tethered end portion 24 and a free end portion 26 opposite the tethered end portion 24. The wand 22 pivots about its tethered end portion 24, oscillating side-to-side; in a plane that is typically approximately orthogonal to an observer's line of vision. By way of example, the wand 22 may oscillate back and forth in directions indicated by double-ended arrow “A” at a rate of approximately 16 oscillations per second. The wand 22 may be oscillated back and forth manually or by an electric motor.

In the embodiment depicted in FIG. 1, the display device 10 includes a motor 28 mounted to a base 30. The motor 28 has a drive axle 32 coupled to the tethered end portion 24 of the wand 22. The motor 28 is configured to cause the drive axle 32 to oscillate and thereby cause the wand 22 to oscillate in directions indicated by double-ended arrow “A.” As the wand 22 oscillates, selected discrete light sources 18A-18H may be illuminated at selected times for a predetermined period of time (e.g., 0.185 milliseconds) and then turned off. The information to be displayed by the wand 22 using the discrete light sources 18A-18H determines which particular light sources are illuminated and when they are illuminated. In other words, the information (in this case, the time “3:08”) viewed by the observer is the result of the careful timing of the illumination of selected discrete light sources 18A-18H as the wand 22 oscillates.

Because the light provided by a discrete light source (e.g., the discrete light source 18A) persists on the retina for a period of time, the retina may perceive all of the illuminations of the discrete light sources 18A-18H occurring during a single oscillation as if they occurred simultaneously even though the light sources may have been illuminated at different times and different wand locations. In this manner, the observer will view the information (e.g., the time “3:08”) as though the information was provided by the two-dimensional array 20, even though the information was provided by the one-dimensional array 19 one wand position at a time. In essence, the two-dimensional array 20 includes the current and past positions of the wand 22 as it oscillates.

In alternate embodiments of the display device 10, instead of producing the two-dimensional array 20 by moving the discrete light sources 18A-18H (e.g., oscillating the wand 22), the two-dimensional array 20 may be constructed using a static array of stationary discrete light sources. The discrete light sources 18A-18H may be arranged in any shape, including square, rectangular, arbitrary, round, oval, hexagonal, octagonal, triangular, and the like, to form the array.

The two-dimensional array 20 depicted in the drawings has an arc-like shape including a predetermined number of rows 34 and columns 35 of discrete light sources positions based upon the times the discrete light sources 18A-18H are illuminated as the wand 22 oscillates. The maximum number of rows is equal to the number of discrete light sources 18A-18H in the one-dimensional array 19. The maximum number of columns of the two-dimensional array 20 is determined by dividing the length of travel of the wand 22 along a single direction (indicated by one of the ends of the double-ended arrow “A”) by the product of the period of time during which a light source is illuminated and the speed at which the wand 22 is traveling. The number of characters that may be displayed may be a function of the number of columns used to provide space between successive characters, the maximum number of columns, and the minimum number of columns required to display a single character.

The display device 10 includes a processor 40 coupled to a memory 44 by a bus 46. Optionally, the processor 40 may be coupled to the motor 28 by a bus 47 and used to provide control instructions to the motor 28. The processor 40 may be implemented using any known technology, such as a microprocessor, microcontroller, application-specific integrated circuit (ASIC), digital signal processor (DSP), and the like. A suitable processor 40 for use with the display device 10 includes any processor suitable for use with the XP3 clock.

The processor 40 may be integrated into an electrical circuit, such as a conventional circuit board, that supplies power to the processor 40. Additional electrical components such as a clock, memory, etc. may be connected to the circuit board allowing electrical communication between the processor 40 and the additional electrical components. However, as will be appreciated by those of ordinary skill in the art, much of the functionality of the additional electrical components could be incorporated into and performed by the processor 40 and such embodiments are within the scope of the present invention.

The processor 40 may include internal memory 44 or memory may be coupled thereto. The memory 44 may comprise random access memory (RAM) and read-only memory (ROM). Optionally, the memory 44 may include external or removable memory devices such as floppy disk drives and optical storage devices (e.g., CD-ROM, R/W CD-ROM, DVD, and the like). The electrical circuit may also include one or more I/O interfaces such as a serial interface (e.g., RS-232, RS-432, and the like), an IEEE-488 interface, a universal serial bus (USB) interface, a parallel interface, and the like, for the communication with removable memory devices such as flash memory drives, external floppy disk drives, and the like. The buses 46 and 47 may include a data bus, control bus, power bus, I/O bus, and the like. The present invention is not limited by the specific hardware component(s) used to implement the processor 40, the memory 44, the bus 46, or the bus 47.

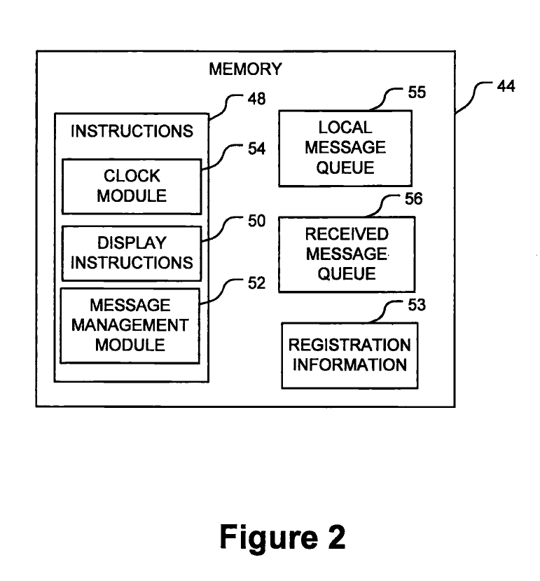

The memory 44 contains instructions and data that control the operation of the processor 40. The memory 44 may also include a basic input/output system (BIOS), which contains the basic routines that help transfer information between elements within the processor 40. As may best be viewed in FIG. 2, the memory 44 includes machine-executable instructions 48 configured for execution by the processor 40. Generally, program modules include function calls, routines, programs, objects, components, data structures, etc., that perform particular tasks or implement particular abstract data types. The modules stored in the memory 44 of the display device 10 may include display instructions 50, a message management module 52, and an optional clock module 54. The memory 44 also includes a data structure, such as a local message queue 55 that stores a record for each local message programmed into the memory 44 by the user.

The memory 44 may store registration information 53 such as a device identifier, secret code, and the like. The registration information 53 may be programmed into the memory 44 by the manufacturer of the display device 10. The registration information 53 may be sent to the remote computer 12 by the display device 10. The remote computer 12 may use the registration information 53 to identify the display device 10. Further, the remote computer 12 may use the registration information 53 to determine whether the display device 10 is authorized to download messages from the remote computer 12. In other words, the registration information 53 may be used to determine whether the device identifier included therein is valid.

The memory 44 also includes a data structure, such as a received message queue 56 that stores a record for each message received from a remote computing device 12 over the network 14. Each record in the received message queue 56 includes the information to be displayed by the display device 10. Optionally, the record may include a received timestamp, indicating when the message was received. Each record in the received message queue 56 may include a “New Message” indicator that may be a Boolean value set to “TRUE” when the record is first created. After the information in the message has been manually scrolled through the display of the display device 10, the “New Message” indicator may be set to “FALSE” by the message management module 52 to indicate the message has been read.

Each of the discrete light sources 18A-18H is coupled to the processor 40, which is operable to power each of the discrete light sources 18A-18H selectively based on the display instructions 50 stored in the memory 44. During operation of the display device 10, the processor 40 executes commands directing it to recall and execute the display instructions 50, which instruct the processor 40 to turn the discrete light sources 18A-18H on and off in a predetermined pattern at predetermined times.

The predetermined pattern may be determined by the one or more local messages stored in the local message queue 55 and/or one or more received messages stored in the received message queue 56. As explained above, each of the local messages and received messages includes information for display by the display device 10. The predetermined pattern is determined as a function of the information in a selected local or received message.

In embodiments in which the display device 10 is a persistence of vision display, the display instructions 50 may include motor control instructions instructing the processor 40 to turn the motor 28 on and off. The motor control instructions may instruct the processor 40 to modify one or more functional parameters of the motor 28, such as the speed at which the motor 28 oscillates the wand 22, the position of the wand 22 at a particular time, and the like. The display instructions 50 may include position instructions for determining the current position of the wand 22. The current position of the wand 22 may be used to time the illumination of the discrete light sources 18A-18H for the purposes of displaying information to the user.

The message management module 52 manages the local message queue 55 and the received message queue 56. The message management module 52 is configured to receive local programming instructions from the user and use those instructions to configure the information in a local message for display by the discrete light sources 18A-18H. The message management module 52 is configured to receive messages from the remote computing device 12 and add those messages to the received message queue 56.

The message management module 52 may be configured to determine when the display device 10 has received a maximum number of messages that can be stored in a message queue on the remote computing device 12. Further, the message management module 52 may be configured to calculate an amount of available capacity on the display device 10 to receive additional messages. The amount of available capacity, a full indicator (indicating the message queue on the remote computing device 12 is storing the maximum number of messages it can store), and the like may be communicated by the message management module 52 to the remote computing device 12. The remote computing device 12 may use this information to determine whether to download messages to the display device 10, how many messages to download to the display device 10, which messages to download to the display device 10, and the like. When the message queue on the remote computing device 12 is storing the maximum number of messages the message queue can store, the remote computing device 12 may stop receiving new messages for the display device 10.

After the information in a received message has been manually scrolled through the display of the display device 10 for the first time, the message management module 52 may set the “New Message” indicator to “FALSE” in the record corresponding to the message in the received message queue 56. While not a requirement, the records in the received message queue 56 may be ordered according to the order in which messages are received. In some embodiments, the message management module 52 is configured to use user preferences, if any, specified by the user to configure the information in a local or received message for display by the discrete light sources 18A-18H.

The message management module 52 may instruct the display instructions 50 to display the information in the messages in the local message queue 55, the received message queue 56, and a combination thereof. By way of example, the message management module 52 may instruct the display instructions 50 to display information in each of the messages in the received message queue 56 in the order in which the messages were received. In some embodiments, the message management module 52 instructs the display instructions 50 to display the oldest message first (i.e., the message received longest ago). Alternatively, the display device 10 may display most recently received message first.

In alternate embodiments, the message management module 52 instructs the display instructions 50 to display a single message selected from one of the local message queue 55 and the received message queue 56 until the user selects a different message for display. In further embodiments, the user may specify a display date and/or time for one or more of the messages in either queue 55 or 56. When the specified date and/or time occurs, the message corresponding thereto is displayed.

If the display device 10 is configured to display the time, the memory 44 includes the clock module 54, which is operable to determine a time value. Methods of implementing clocks are well known in the art and will not be described in detail. The display instructions 50 may access the clock module 54 to receive the time value therefrom. Then, the display instructions 50 may display the time value to the user using the discrete light sources 18A-18H of the display device 10. The display device 10 may be configured to display the information in the message(s) and the time in an alternating or similar manner.

In some embodiments, the display device 10 may be configured to automatically adjust its time to the local time by checking with a time server through Internet.

In further embodiments, the message management module 52 instructs the display instructions 50 to display the most recently received message in the received message queue 56. In such embodiments, after a message is received by the display device 10, it is immediately displayed without the need for any intervention by the user. Optionally, such embodiments may allow the user to select one or more messages for display by the display device 10 that supersede newly downloaded messages. In this manner, the display device 10 may be configured to automatically display new messages as they are received or alternatively, one or more messages selected by the user for display. In either case, the display device 10 may be configured to display the information in the message(s) and the time in an alternating or similar manner.

As illustrated in FIG. 1, the display device 10 includes a user interface 60 coupled to the processor 40 by the memory 44 and a bus 61. The bus 61 may be constructed using any bus discussed above as suitable for constructing bus 46. Optionally, the user interface 60 may include basic control buttons such as an “on/off” button (not shown) that allows the user to turn the display device 10 on and off (e.g., power up and power down the processor 40 and/or the motor 28). The user interface 60 may be used to provide programmable parameter values to existing programs (e.g., if the display device 10 includes a clock, the user interface 60 may be used to set the clock to the correct local time), to modify the computer-executable instructions 48 stored in the memory 44, to add new computer-executable instructions to the memory 44 (e.g., program the display device 10 to display new information), to add a new local message to the local message queue 55, to delete a local message from the local message queue 55, to modify a local message stored in the local message queue 55, to delete a received message from the received message queue 56, to modify a received message in the received message queue 56, and the like.

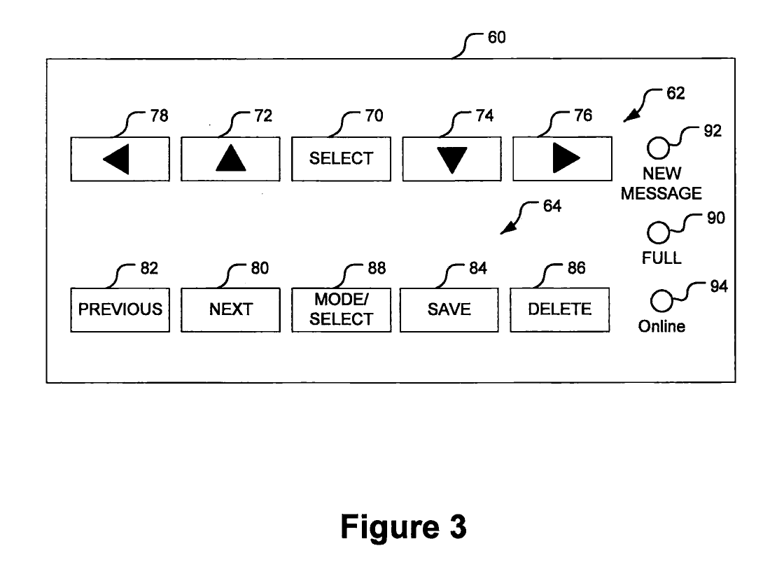

The user interface 60 may interact with the instructions included in the message management module 52 and provide user specified values thereto. As explained above, some embodiments of the display device 10 are configured to display locally programmed messages as well as messages received over the network 14. Therefore, as may best be viewed in FIG. 3, the user interface 60 may include a local message user interface 62 and a separate received message interface 64. Each of the user interfaces 62 and 64 may be used to manage the local message queue 55 and the received message queue 56 (see FIG. 2), respectively.

However, as is apparent to those of ordinary skill in the art, a single interface may be used with respect to local and received messages and such embodiments are within the scope of the present invention. By way of a non-limiting example, the user interface 60 may include a “SELECT/MODE” button (e.g., one of a “SELECT” button 70 and a “MODE” button 88) that may be pressed to selectively place the display device 10 in a local/clock mode and a remote message mode. By way of a non-limiting example, the display device 10 may be toggled between local/clock mode and remote message mode by pressing and holding the “SELECT/MODE” button down for more than a predetermined number of seconds (e.g., 3 seconds). The “SELECT/MODE” button may also act as a “SELECT” button allowing users to indicate or confirm a selection in the local/time clock mode. For example, the “SELECT/MODE” button may act as a SELECT button when pressed for fewer than the predetermined number of seconds. The functionality of the other buttons (described below) of the user interface 60 may depend upon the mode of the display device 10.

### Local Message User Interface 62

Referring to FIG. 3, local messages may be programmed into the display device 10 locally using the local message user interface 62. The local message user interface 62 may include any suitable interface known in the art, including the user interface incorporated into the XP3 clock. By way of non-limiting example, the local message user interface 62 may include five buttons: a “SELECT” button 70, an “UP” button 72, a “DOWN” button 74, a “RIGHT” button 76, and a “LEFT” button 78. The center or “SELECT” button 70 may be pressed to indicate the user would like to program a message and the other buttons may be used to provide a value for each of the various parameters of the message.

For example, the “SELECT” button 70 may be pressed a predetermined number of times (e.g., six) to indicate the user would like to access a message programming menu. The discrete light sources 18A-18H may be used to generate a display indicating the user's selection(s) while the local message is programmed. The “RIGHT” button may be pressed to select a first message, identified by the discrete light sources 18A-18H as “MSG 1.” Optionally, the “UP” button 72 and the “DOWN” button 74 may be used to select other messages (e.g., a second message identified by the discrete light sources 18A-18H as “MSG 2”).

After a message is selected, the “SELECT” button 70 may be pressed to indicate the user would like to enter information into the message. The “UP” and “DOWN” buttons 72 and 74 may be used to select characters (i.e., to scroll through the alphabet, numbers, and symbols available) to insert into the message. The “RIGHT” and “LEFT” buttons 76 and 78 may be used to move between characters. For example, the “RIGHT” button may be used to advance to the next character or empty space to the right of the present location. As mentioned above, the discrete light sources 18A-18H may display a predetermined maximum number of characters (e.g., 12 characters). A predetermined symbol, such as the carriage return or enter key, may be used to instruct the display device 10 where to break messages longer than the predetermined maximum number of characters.

The local message user interface 62 may be used to specify display parameters. By way of non-limiting example, when the user is accessing the message programming menu, the discrete light sources 18A-18H may display the following information “MESSAGES BRD” indicating the manner in which information is displayed may be selected. When “MESSAGES BRD” is displayed, the “UP” button 72 may be pressed to instruct the display device 10 to display the information in a continuously scrolling reader-board fashion (“MESSAGES SCR”). The “UP” button 72 may be pressed a second time to instruct the display device 10 to display the information in another manner (e.g., “MESSAGES BRD”). The “DOWN” button 74 may be pressed to turn the information display off. When this occurs, the discrete light sources 18A-18H may display a message such as “MESSAGES OFF.” In embodiments in which the display device 10 is a clock, turning the information display off does not necessarily affect displaying the time.

One of the buttons (e.g., the “RIGHT” button 76) may be used to select one of the local messages stored in the local message queue 55 (see FIG. 2) as a daily message to be displayed everyday. Another button (e.g., the “UP” button 72) may be used to select a particular date on which to display the information in a selected local message. The “LEFT” button 78 may be pressed to exit the message programming menu.

The completion of the programming may be communicated to the display device 10 by pressing the SELECT button 70. Optionally, the display device 10 may display a message, such as “EXIT,” indicating programming has been completed. The local message user interface 62 may also be used to provide the current local time to the clock module 54 in much the same way the time displayed by a digital watch is set.

### Received Message User Interface 64

The display device 10 includes a received message user interface 64, which may best be viewed in FIG. 3. The received message user interface 64 may interact with the instructions included in the message management module 52 and provide user specified values thereto. The received message user interface 64 may communicate with the received message queue 56 via the message management module 52. The received message user interface 64 may be used to communicate user selections to the message management module 52 for the purposes of navigating the received message queue 56 and selecting a message stored therein for display by the display device 10.

By way of non-limiting example, the received message user interface 64 may include five buttons: a “NEXT” button 80, a “PREVIOUS” button 82, a “SAVE” button 84, a “DELETE” button 86, and a “MODE” button 88. The user may press the “NEXT” button 80 to select the next message in the received message queue 56 for display by the display device 10. The user may press the “PREVIOUS” button 82 to select the previous message in the received message queue 56 for display by the display device 10. If the user selects a message that is not available in the received message queue 56, the display device 10 will contact the remote computing device 12 to download the message. The “DELETE” button 86 deletes the record in the received message queue 56 storing the information being displayed by the display device 10. In some embodiments, all of the records in the received message queue 56 may be deleted by depressing the “delete” button for at least a predetermined period of time (e.g., 3 seconds). After a message is deleted from the received message queue 56, the display device 10 sends a delete message to the remote computing device 12 instructing it to also delete the message from the message queue on the remote computing device 12.

The “SAVE” button 84 adds a new record to the local message queue 55 (see FIG. 2) by storing therein the information currently being displayed. In other words, the “SAVE” button 84 copies the message currently being displayed from the received message queue 56 to the local message queue 55.

As mentioned above, the “MODE” button 88 allows the user to select a mode of operation for the display device 10. For example, the display device 10 may have two modes of operation. The first mode may be the “clock/local” mode. In this mode, the display device 10 may display the time and a local message stored in the local message queue 55. The local messages may have been programmed locally by the user using the local message user interface 62 (or the like) or selected from the messages received by the display device 10 from the remote computing device 12 over the network 14.

The second mode of operation may include the “remote message” mode. In this mode, the display device 10 displays messages received from the remote computing device 12 over the network 14 (i.e., one or more of the messages stored in the received message queue 56).

As mentioned above, the display device 10 may include a single user interface and the functionality of the buttons other than the MODE button 88 may depend upon the mode of the display device 10. Because the embodiment of the user interface 60 depicted in the figures includes both the local message user interface 62 and the separate received message interface 64, the user interface 60 includes both the SELECT button 70 and the MODE button 88, respectively. However, in alternate embodiments, the user interface 60 may include a single “SELECT/MODE” button.

For the purposes of describing a single user interface 60 embodiment, it will be assumed only the buttons of the received message interface 64 have been included in the user interface 60. Therefore, only the MODE button 88 is present. When the display device 10 is in the remote message mode, the buttons 80, 82, 84, 86, and 88 are associated with the functions described above with respect to the received message interface 64. However, when the display device 10 is in the clock/local mode, the buttons 80, 82, 84, 86, and 88 are associated with the functions described above with respect to the buttons 74, 72, 78, 76, and 70, respectively. While the aforementioned mapping of the buttons 80, 82, 84, 86, and 88 to the buttons 70, 72, 74, 76, and 78 has been provided for illustrative purposes, those of ordinary skill in the art appreciate that alternate mappings are possible and within the scope of the present teachings.

Optionally, the received message user interface 64 may include status indicators. For example, the received message user interface 64 may include a “FULL” indicator 90 that indicates the message queue on the remote computing device 12 configured to receive and store messages for the display device 10 is storing a maximum number of messages permitted. This maximum number may be determined by an administrator of the remote computing device 12.

By way of another non-limiting example, the received message user interface 64 may include an “NEW MESSAGE” indicator 92 that indicates a message has been received that has not yet been manually scrolled through the display of the display device 10. When the “NEW MESSAGE” indicator 92 indicates a message has been received that has not yet been manually scrolled through the display of the display device 10, the user may select the new message for display by pressing the “NEXT” button 80 until the message is selected and displayed.

Optionally, the user interface 60 may include an “ONLINE” indicator 94 that indicates when a connection exists between the display device 10 and the Internet.

### Network Interface

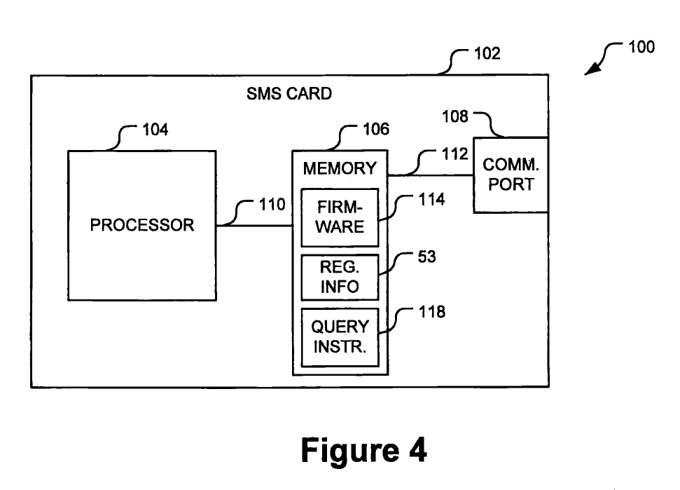

Returning to FIG. 1, the display device 10 includes a network interface 100 configured to communicate with the remote computing device 12 over the network 14 such as the Internet. Referring now to FIG. 4, the network interface 100 may include any suitable interface known in the art for coupling a device, such as the display device 10, to the Internet. By way of a non-limiting example, the network interface 100 may include a short message service (“SMS”) card 102. SMS cards are well known in the art; therefore, SMS card 102 will not be described in detail.

As is appreciated by those of ordinary skill in the art, the exemplary SMS card 102 depicted in the drawings includes a processor 104 coupled to a memory 106 and a communication port 108, such as an Ethernet port, wireless connection port (e.g., an antenna), and the like. The memory 106 may store the registration information 53, such as a serial number, secret code, and the like, which may be used by the remote computer 12 to identify the display device 10. The registration information 53 may be copied to the memory 106 from the memory 44 by the processor 104. Alternatively, the processor 40 may store the registration information 53 in the memory 106. By way of another example, the registration information 53 may be stored in the memory 106 by the manufacturer of the display device 10 or the manufacturer of the SMS card 102. As is apparent to those of ordinary skill, the communication port 108 may be coupled to the network 14 via a modem (which may be substantially similar to a modem 154 described below). The components of the SMS card 102 may be coupled together by buses 110 and 112. Each of the buses 110 and 112 may include a data bus, control bus, power bus, I/O bus, and the like.

By way of a non-limiting example, the SMS card 102 may include a microcontroller that integrates an Ethernet interface with a TCP/IP stack. The memory 106 coupled to the microcontroller may include 64 kilobytes of ROM, 1 Megabyte of RAM, and 1 Megabyte of flash memory. The 64 kilobytes of ROM may store firmware 114 that connects to the network via the Ethernet interface using Dynamic Host Configuration Protocol (“DHCP”) and Trivial File Transfer Protocol (“TFTP”). Alternatively, other file transfer protocols such as File Transfer Protocol (“FTP”), and the like may be used. The firmware may also support User Datagram Protocol (“UDP”), Transmission Control Protocol (“TCP”), Internet Control Message Protocol (“ICMP”), and Internet Group Management Protocol (“IGMP”).

The memory 106 includes instructions for sending and receiving messages over the network 14 via the communication port 108. The received messages may be stored in the memory 106 and subsequently transferred to memory 44. Returning to FIG. 1, the processor 40 is coupled to the network interface 100 (e.g., SMS card 102) via the memory 44 and a bus 116 and is operable to access the memory 106 for the purposes of retrieving the messages stored therein. In alternate embodiments, the processor 104 of the SMS card 102 may transmit the received messages directly to the memory 44 for access by the processor 40 via the bus 46.

The registration information 53 may act as a device identifier (e.g., a serial number) for the display device 10. The display device 10 uses the network interface 100 to send a request message to the remote computing device 12 including the registration information 53 identifying the display device 10 and thereby the user associated therewith. The display device 10 may send the request message each time the display device 10 connects to the network 14. In some embodiments, the display device 10 sends the request message occasionally, such as periodically (e.g., about every 3 minutes), at random intervals, and the like.

The following approach may help reduce the number of request messages sent by the display device 10 to the remote computing device 12. In the received message queue 56, the “NEW MESSAGE” indicator of the record associated with a new message is set to “TRUE” until the message is scrolled through the display of the display device. If there are new messages in the received message queue 56, the “NEW MESSAGE” indicator 92 will indicate new messages have been received and the display device will stop sending request messages. On the other hand, if there are no new messages in the received message queue 56, the device will send the request message occasionally, as described above. If the remote computing device 12 receives a new message for the display device, the display device will download the new message, use the “NEW MESSAGE” indicator 92 to indicate a new message has been downloaded, and will stop sending request messages to the remote computing device 12. As mentioned above, the display device 10 may also automatically display the new message after downloading it from the remote computing device 12.

Messages are downloaded in a batch into the received message queue 56 of the display device 10. When the user requests a message that is not available in the received message queue 56 (read or unread), the display device 10 connects to the Internet and downloads a number of messages based on the number of empty spots in the received message queue 56. New message(s) may be downloaded first.

The memory 106 of the SMS card 102 may be preprogrammed before sale of the display device 10 to the user with sufficient information (e.g., IP address, domain name, telephone number, and the like) to locate the remote computing device 12 on the network 14. In this manner, when the display device 10 is coupled to the network 14 by the user, the display device 10 may immediately begin receiving messages.

The memory 106 of the SMS card 102 includes query instructions 118 for instructing the processor 104 to periodically (e.g., about every 3 minutes) send the request message to the remote computing device 12 thereby querying the remote computer for messages, and if messages are found, download them to the memory 106.

While the network interface 100 has been described as including the SMS card 102 having discrete components, it is apparent to those of ordinary skill in the art that the functionality of the components described in relationship to the network interface 100 may be incorporated into other components of the display device 10 and such embodiment are within the scope of the present teachings. For example, the same processor may be used for both the network interface 100 and to illuminate the discrete light sources 18A-18H.

In an alternate embodiment, instead of the SMS card 102, the network interface 100 may include an external SMS kit (not shown) configured to connect to the display device to the Internet using a RJ11 cable (phone cable).

The message management module 52 may use the network interface 100 to communicate status information related to the display device 10 to the remote computing device 12. For example, the message management module 52 may send a message to the remote computing device 12 including a capacity indicator indicating the capacity of the display device 10 to receive new messages, a full indicator, and the like.

### Computing Devices

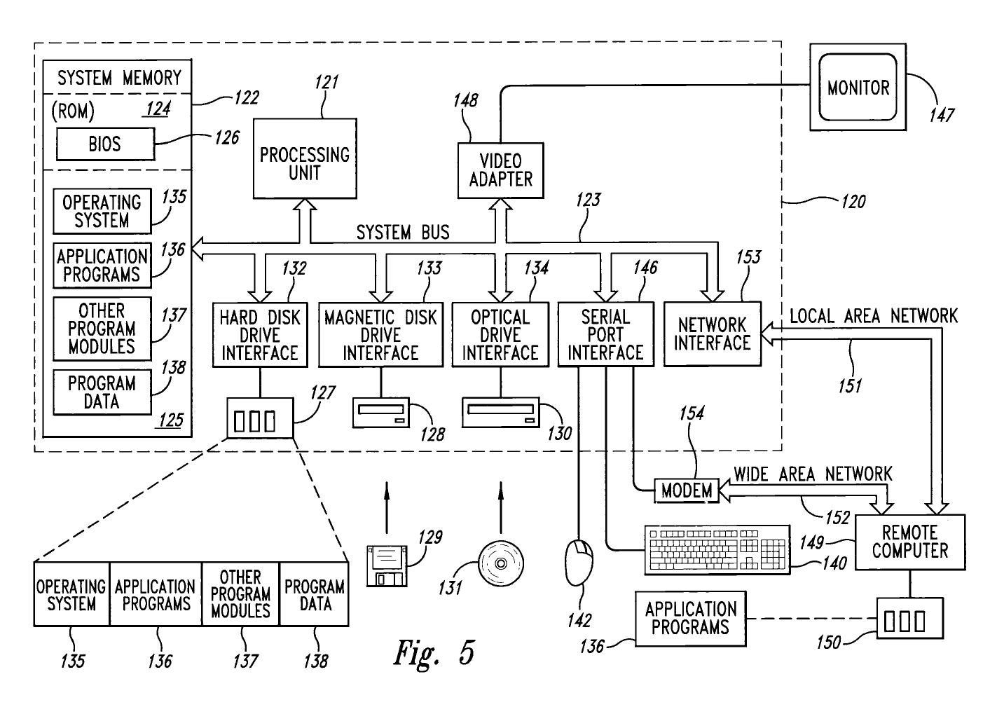

Referring to FIG. 5, the remote computing device 12 and client computing device 16 may each be implemented on a computing device 120. The description of FIG. 5 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include function calls, routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 5 includes the computing device 120, which may be a general-purpose computing device of any type known in the art, including a processing unit 121, a system memory 122, and a system bus 123 that operatively couples various system components, including the system memory 122, to the processing unit 121. There may be only one or there may be more than one processing unit 121, such that the processor of computing device 120 comprises a single central-processing unit (CPU), or a plurality of processing units, commonly referred to as a parallel processing environment. The computing device 120 may be a conventional computer, a distributed computer, or any other type of computer.

The system bus 123 may include any bus structure including a memory bus or memory controller, a peripheral bus, and a local bus using any of a variety of bus architectures. The system memory 122 may also be referred to as simply the memory, and includes read only memory (ROM) 124 and random access memory (RAM) 125. A basic input/output system (BIOS) 126, containing the basic routines that help to transfer information between elements within the computing device 120, such as during start-up, is stored in ROM 124. The computing device 120 further includes a hard disk drive 127 for reading from and writing to a hard disk, not shown, a magnetic disk drive 128 for reading from or writing to a removable magnetic disk 129, and an optical disk drive 130 for reading from or writing to a removable optical disk 131 such as a CD ROM or other optical media.

The hard disk drive 127, magnetic disk drive 128, and optical disk drive 130 are connected to the system bus 123 by a hard disk drive interface 132, a magnetic disk drive interface 133, and an optical disk drive interface 134, respectively. The drives and their associated computer-readable media provide nonvolatile storage of computer-readable instructions, data structures, program modules, and other data for the computing device 120. It should be appreciated by those skilled in the art that any type of computer-readable media, which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk drive 127, magnetic disk 129, optical disk 131, ROM 124, or RAM 125, including an operating system 135, one or more application programs 136, other program modules 137, and program data 138. A user may enter commands and information into the personal computing device 120 through input devices such as a keyboard 140 and pointing device 142. Other input devices (not shown) may include a microphone, joystick, game pad, satellite dish, scanner, or the like. These and other input devices are often connected to the processing unit 121 through a serial port interface 146 that is coupled to the system bus 123, but may be connected by other interfaces, such as a parallel port, game port, or a universal serial bus (USB). A monitor 147 or other type of display device is also connected to the system bus 123 via an interface, such as a video adapter 148. In addition to the monitor, computers typically include other peripheral output devices (not shown), such as speakers and printers.

The computing device 120 may operate in a networked environment using logical connections to one or more remote computers, such as remote computer 149. These logical connections are achieved by a communication device coupled to or a part of the computing device 120 (as the local computer). Implementations are not limited to a particular type of communications device. The remote computer 149 may be another computing device substantially similar to computing device 120, a server, a router, a network PC, a client, a peer device or other common network node, and typically includes many or all of the elements described above relative to the computing device 120, although only a memory storage device 150 has been illustrated in FIG. 5. The logical connections depicted in FIG. 5 include a local-area network (LAN) 151 and a wide-area network (WAN) 152. Such networking environments are commonplace in offices, enterprise-wide computer networks, intranets, and the Internet. The network 14 (see FIG. 1) may include any of these networking environments.

When used in a LAN-networking environment, the computing device 120 is connected to the local network 151 through a network interface or adapter 153, which is one type of communications device. When used in a WAN-networking environment, the computing device 120 typically includes a modem 154, or any other type of communications device for establishing communications over the wide area network 152, such as the Internet. The modem 154, which may be internal or external, is connected to the system bus 123 via the serial port interface 146. In a networked environment, program modules depicted relative to the personal computing device 120, or portions thereof, may be stored in a remote memory storage device. It is appreciated that the network connections shown are exemplary and other means of and communications devices for establishing a communications link between the computers may be used.

The computing device 120 and related components have been presented herein by way of particular example and also by abstraction in order to facilitate a high-level view of concepts involved. The actual technical design and implementation may vary based on particular implementation while maintaining the overall nature of concepts disclosed.

### Communication System

In the embodiment depicted in FIG. 1, the remote computing device 12 may function as a message server that receives messages from one or more other remote computing devices (e.g., the client computing device 16) coupled to the network 14. Together the display device 10, the remote computing device 12, the network 14, the client computing device 16 form a communication system 158. While for ease of illustration, the drawings depict the single client computing device 16, it is appreciated by those of ordinary skill in the art that the communication system 158 is not limited to the single client computing device 16 depicted and any number of client computing devices may be coupled to the remote computing device 12 via the network 14 and used to send messages to the remote computing device 12 for the display device 10.

When the display device 10 is coupled to the network 14 for the first time, the display device sends a first message request to the remote computer 12. The message request includes the registration information 53 (see FIGS. 2 and 4). After the first message request, as mentioned above, the display device 10 continues to send a request message occasionally, such as periodically, at random intervals, and the like.

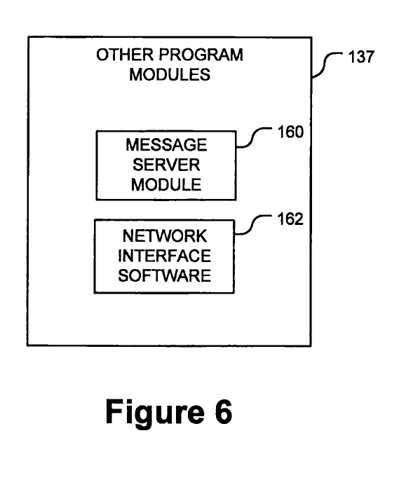

Referring to FIG. 6, in such embodiments, the other program modules 137 stored in memory 122 of the remote computing device 12 include a message server module 160, and network based software 162, such as a web based software components for communicating with the client computing device 16 over the network 14. In some embodiments, the network based software 162 is configured to generate a web interface accessible by the client computing device 16. The web interface allows the user to enter a message for the display device 10. In such embodiments, the message server module 160 may be configured to create user accounts. To send a message for display on a particular recipient display device 10, a user may be required to have an account with the message server module 160. However, in alternate embodiments, this is not a requirement.

In some embodiments, the client computing device 16 may access the message server module 160 of the remote computing device 12 using a web browser program, an email program, and the like. In such embodiments, the memory 122 of the client computing device 16 need not include specialized software modules.

The message server module 160 receives messages for download to the display device 10 in a device account associated the display device 10. The device account may be created automatically by the message server module 160 after it receives the first request message from the display device 10. The message server module 160 uses the registration information 53 in the first request message to identify the display device 10 and determine that it is authorized to receive messages received by the remote computer 12.

To receive messages on the display device 10, the user (or owner) sets up a user account with the message server module 160. To create the user account, the user supplies a unique user account name to the message server module 160. As is apparent to those of ordinary skill in the art, because the remote computer 12 is used by a plurality of users, the user account name associate with each user should be unique. The message server module 160 may include an interface that helps the user select an account name that is unique to the user. For example, the user may be asked to provide a candidate user account name that message server module 160 verifies is not associated with another user account. If candidate user account name is associated with another user account, the message server module 160 may require the user to enter another candidate account identifier until the user provides a unique candidate account identifier. After selecting a user account name, the user selects a password to provide secure access to his/her user account.

The message server module 160 may be configured to allow the owner of the display device 10 to access his/her user account. For example, the user may access his/her account by providing the user account name and password to the message server module 160.

After the user account is setup, the user accesses his/her user account and registers the display device 10 with the user's user account, which associates the device account automatically created by the remote computing device 12 with the user's user account. To register the display device 10, the user enters a device identifier (e.g., serial number) associated with the display device (e.g., provided with the device by its manufacturer). The device identifier may be identical to a corresponding device identifier included in the registration information 53 included in the first request message, although this is not a requirement. The user may provide the device identifier by typing it into a web-based interface generated by the network-based software 162.

The user may provide the device identifier by typing it into a web-based interface generated by the network-based software 162. The message server module 160 allows the user to register multiple display devices under the user's account using different device names thereby associating the automatically created device accounts with the appropriate user account.

The user account name and device name are each used as part of a device address. The device address may have the following format: [user account name].[device name]. For example, if user “Bill Hones” creates a user account having the user account name “BillH” and registers four display devices 10 named “Seattle,” HongKong,” “China,” and “Vietnam” under his user account, those display devices may have the following device addresses “BillH.Seattle,” “BillH.HongKong,” “BillH.China,” and “BillH.Vietnam,” respectively. A message can be sent from a sender via the Internet to any of these devices or to all of them. However, the sender does not necessarily need to remember the device name as he/she may select it from the list of device names available to receive messages provided under the user account.

The message server module 160 is configured to allow the user to change the password associated with the user's user account, register new display devices, un-register (or remove) display devices, change the device name associated with a device account, and the like. The message server module 160 may allow the user to enable or disable a particular display device 10.

The user of the display device 10 may provide the device address to his/her friends, family, and the like, who may in turn use the device address to send messages to the display device 10. The network-based software 162 generates a web interface that allows anyone who knows the device address of the display device 10 to enter a message for the display device 10. The sender may identify a recipient display device for the message by entering its device address. In this manner, the sender need not know the device identifier (e.g., serial number) associated with the display device 10.

The message server module 160 may allow users to view a list of display devices registered with a particular user account. For example, the message server module 160 may include a lookup function that allows a sender to enter a user account name. The message server module 160 uses the user account name to display a list of names of display devices associated with the particular user. A disabled display device will not appear in the list of display devices associated with the user account. The list may provide a checkbox next to the device names that allows the sender to indicate to which device names the message is to be sent. The web interface may include a “Check All” button that allows the sender to send the message to all of the device names registered with the user account name that are enabled.

If the display device 10 begins receiving unwanted messages from a sender, the owner of the display device may simply access his/her account, change the device name, and provide the new device address to parties from whom the owner would like to receive messages.

The web based interface allows the owner of the display device 10 to view messages stored in the device accounts associated with his/her user account. The user may delete messages stored in the device accounts associated with his/her user account. Messages are stored in the device accounts until they are deleted by the user. A message may be deleted in one of two ways. First, the user may use the web based interface to delete the message. Second, the user may delete the message using the “DELETE” button 86 of the received message user interface 64 of the display device 10 (see FIG. 3). After the user presses the “DELETE” button 86, the display device 10 sends a delete message to the remote computing device 12 instructing it to delete the message from the device account associated with the display device.

The message server module 160 may assist the sender prepare information for display by the display device 10. For example, the message server module 160 may alert the sender if a message is too long for display by the display device 10. Similarly, the message server module 160 may allow the sender to specify how a message that is too long should be broken up for display. The message server module 160 may also notify the sender that the display device 10 has received the maximum number of messages and cannot receive more. The sender may then contact the owner of the display device 10 and request that he/she delete one or more messages so that the sender may send a new message to the display device 10.

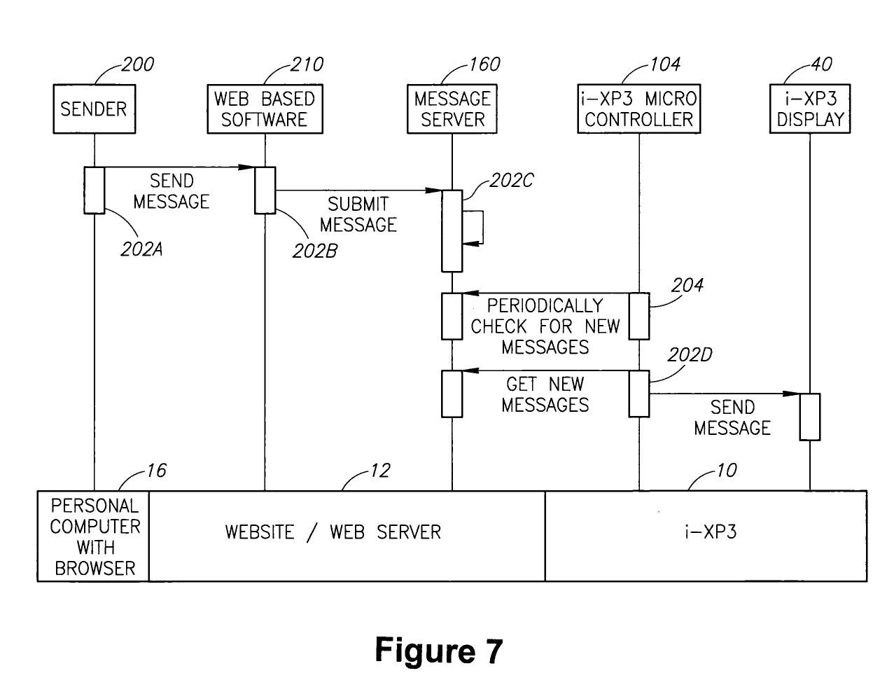

FIG. 7 provides an interaction diagram illustrating exemplary interactions between the display device 10, the remote computing device 12, and the exemplary client computing device 16. In this diagram, the user of the client computing device 16 is identified as the “sender” 200 of a message 202A. The sender 200 uses web based software 210 (e.g., a web browser, email client, and the like) to send the message 202B (communicating the sender's message 202A) to the message server module 160 of the remote computing device 12. The message server module 160 receives and stores a message 202C (including the sender's message 202A).

In the embodiment depicted in FIG. 7, the query instructions 118 (see FIG. 4) of the network interface 100 instruct the processor 104 to query the remote computing device 12 for messages for the user. The processor 104 formulates a query or request message 204 and sends it to the message server module 160 of the remote computing device 12. In response to receiving the request message 204, the message server module 160 determines whether it is storing a message for delivery for the display device 10. In this example, the message server module 160 determines it is storing the message 202C, which the message server module 160 forwards to the memory 106 of the network interface 100 in response to having received the request message 204 therefrom. Alternatively, the message server module 160 may send a reply (not shown) to the network interface 100 indicating the message server module has the message 202C for delivery to the display device 10. After receiving this reply, the processor 104 may request the message 202C or may otherwise receive the message 202C from the message server module 160.

The message 202C is received into the memory 106 of the network interface 100 as a message 202D (including the sender's message 202A). As explained above, the message 202D is added to the received message queue 56 (see FIG. 2) by the message management module 52. After this occurs, the information contained in the message 202D may be displayed by the display device 10 by the processor 40 executing the display instructions 50.

Because the display device 10 requests messages from the remote computing device 12 directly, the user need not manually download messages to the display or program the display device 10 locally. Also, because the display device 10 requests messages from the remote computing device 12, a firewall or similar security measure may not block the downloaded messages reaching the display device 10, which could be the case if the remote computing device 12 sent the messages to the display device without first receiving a request message therefrom. Further, an operator of the remote computing device 12 may send messages, such as announcements and advertisements, to the display device 10 which will display them in an eye-catching manner which may be more likely to be noticed than a communication displayed on a common computer monitor.

The display device 10 may be moved to a different location in the network without any need for the user to configured the device. The user also does not need to know the IP address of the new location and the IP address of the new location does not have to be a static IP address.

Unlike email, which requires action on the part of the user to view the information in a message (such as connecting to the internet, executing the email client software, downloading messages from the email server, selecting messages to read, and the like), the display device 10 may display the information in a message automatically immediately after it is received without any intervention from the user (or owner) in a manner likely to get the attention of the user. Further, unlike an email message or a page, which both require that the recipient of a message be positioned near a monitor or similar display, the display device 10 may be viewed at a distance from many locations in a room or similar space. The user may notice immediately upon entering a room in which the display device 10 is located that he/she has received a new message. Messages of a surprising nature, such as “Happy Birthday,” may be delivered to surprise the user. Emergency or otherwise important messages, such as “Call Jane,” may be delivered quickly and in a manner less likely to be ignored and without requiring any action on the part of the user other than looking at the display device 10. Further, the display device 10 can be setup to deliver personal and surprising messages when connected to the Internet for the first time.

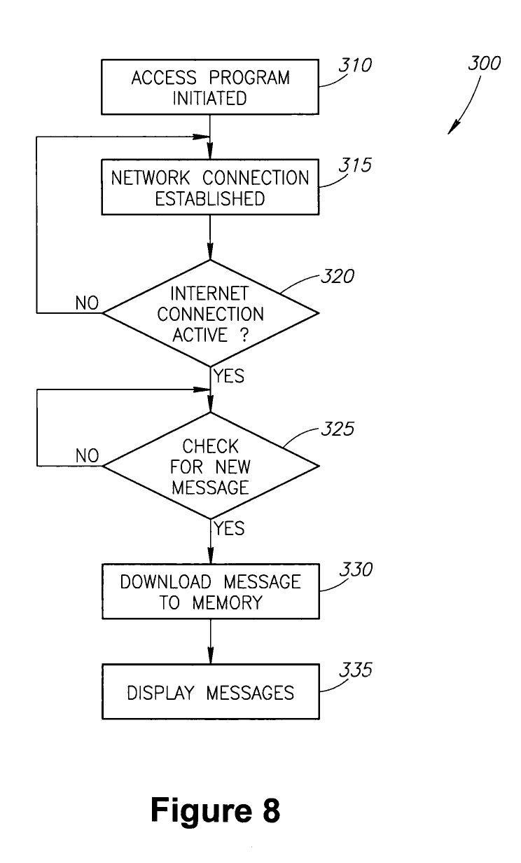

FIG. 8 provides a flow diagram illustrating an exemplary method 300 performed by the display device 10. In block 310, the processor 104 of the network interface 100 executes instructions stored in the memory 106 (e.g., in firmware 114) initiating the establishment of a connection with the network 14. In block 315, a connection with the network 14 is established.

In decision block 320, the processor 104 monitors the network connection to determine whether it is active. If the network connection is active (i.e., the decision is “YES”), in subsequent decision block 325, the query instructions 118 instruct the processor 104 to check or query for messages on the remote computing device 12. If the network connection is not active (i.e., the decision is “NO”), the method 300 returns to before block 315 and attempts to establish a connection with the network 14. The monitoring occurring in decision block 320 may be performed continuously by the display device 10.

In subsequent decision block 325, the query instructions 118 instruct the processor 104 to check or query for messages on the remote computing device 12 by sending a request message thereto. Like the monitoring occurring in decision block 320, sending request messages may be conducted continuously so long as the network connection is active. If the decision in decision block 325 is “YES,” messages are present on the remote computing device 12 for the display device 10. In block 330, those messages are downloaded from the remote computing device 12. Then, in block 335, the messages downloaded from the remote computing device 12 are displayed using the discrete light sources 18A-18H of the display device 10. If the decision in decision block 325 is “NO,” messages are not present on the remote computing device 12, and the display device 10 takes no action but continues monitoring the connection in decision block 320 and sending request messages requesting new messages in decision block 325.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A display device configured to use an array of discrete light sources to display information, the device comprising:
a memory storing computer-executable instructions, a unique identifier for the display device, and an address of a remote computer;
a network interface couplable to a network and configured to use the address of the remote computer to send message requests comprising the unique identifier periodically to the remote computer over the network, the message requests each configure to request that the remote computer use the unique identifier for the display device to identify any messages received by the remote computer for the display device, the network interface being further configured if the remote computer identifies a message comprising information for display by the device, to download the message from the remote computer; and
a processor coupled to the memory and the array of discrete light sources, the processor being operable to execute the computer-executable instructions stored in the memory and to turn selected ones of the discrete light sources on and off, the computer-executable instructions including instructions for instructing the processor to turn selected ones of the discrete light sources on and off at appropriate times to display the information of the downloaded message.

2. The device of claim 1, wherein:
the memory stores a data structure configured to store messages;
the downloaded message is stored in the data structure; and
the computer-executable instructions include instructions for instructing the processor to obtain the information of the downloaded message from the data structure.

3. The device of claim 1 for use by a user, wherein:
the memory stores a first data structure configured to store downloaded messages and a second data structure configured to store local messages, each local message including information for display by the device using the array of discrete light sources, the second data structure storing at least one local message,
the downloaded message is stored in the first data structure; and
the computer-executable instructions include:
instructions for instructing the processor to obtain the information of the downloaded message from the first data structure,
instructions for instructing the processor to obtain the information of the at least one local message from the second data structure, and
instructions for instructing the processor to turn selected ones of the discrete light sources on and off at appropriate times to display the information of the at least one local message, and
the device further comprising, a user interface configured to allow the user to select whether the processor executes the instructions for obtaining the information of the downloaded message from the first data structure and displaying the information of the downloaded message, or the instructions for obtaining the information of the at least one local message from the second data structure and displaying the information of the at least one local message.

4. The device of claim 1 for use by a user, wherein if the remote computer identifies a plurality of messages comprising information for display by the device, the network interface is configured to download the plurality of messages from the remote computer.

5. A system for displaying messages to a user comprising:
a message server coupled to a network and configured to:
automatically create a device account in response to a first time the message server receives a message request comprising a particular valid device identifier, the device account being configured to associate the valid device identifier with a selected identifier,
receive messages addressed to the selected identifier from a plurality of computing devices over the network, and
in response to receiving subsequent message requests including the particular valid device identifier, determine whether any messages were received for the selected identifier associated with the particular valid device identifier; and
a display device couplable to the network and configured to:
send a first message request comprising a unique valid device identifier for the display device over the network to the message server, the first message request causing the message server to create a device account associated with the unique valid device identifier,
send subsequent message requests comprising the unique valid device identifier for the display device periodically over the network to the message server causing the message server to determine whether any messages were received for the display device,
if the message server determines at least one message was received for the display device, download the at least one message from the message server, and
display information included in the at least one message downloaded from the message server.

6. The system of claim 5, wherein the message server further comprises:
a user interface configured to receive the unique valid device identifier for the display device and a selected identifier from a user, the message server being further configured to associate the unique valid device identifier for the display device with the selected identifier received by the user interface.

7. A method of communicating information to a plurality of users for display by a plurality of display devices, each display device being coupled to a network and having a unique device identifier, the method comprising:
providing a message server having an account corresponding to each of the unique device identifiers of the display devices, each account also being associated with a selected identifier, the message server being configured to receive a plurality of messages from one or more senders over the network, each message of the plurality of messages being addressed to a selected identifier and including information for display by the display device having a device identifier associated with the selected identifier;
receiving at the message server, a request from each display device of the plurality of display devices, the request requesting messages addressed to the selected identifier associated with the unique device identifier of the display device, the request including the unique device identifier of the display device;
in response to each request, providing from the message server to the display device from which the request was received one or more messages addressed to the selected identifier associated with the unique device identifier of the display device from which the request was received; and
at each display device, displaying the information of the one or more messages provided by the message server.

8. The method of claim 7, wherein the provided message server is further configured to receive a portion of the plurality of messages as email containing a selected identifier of a particular display device of the plurality of display devices and information for display by the particular display device.

9. The method of claim 7, wherein the message server comprises a user interface accessible over the network and each of the one or more senders provides a message of the plurality of messages received by the message server by:
accessing the user interface of the message server over the network,
providing the unique device identifier to the message server, the unique device identifier comprising valid user account information and a display device name,
entering the information included in the message, and
instructing the messaging server to send the message to the display device.

10. The method of claim 7, wherein the message server comprises a user interface accessible over the network and each of the one or more senders provides a message of the plurality of messages received by the message server by:
accessing the user interface of the message server over the network,
providing the selected identifier to the message server, the unique device identifier comprising valid user account information and a display device name
entering the information included in the message, and
instructing the messaging server to send the message to the display device.

11. The method of claim 7, wherein each request sent from a display device of the plurality of display devices comprises a capacity indicator indicating how many messages the display device has capacity to receive, and
the message server providing one or more messages to the display device from which the request was received only if the capacity indicator indicates the message server has not reached a limit of the number of messages that can be received which further indicates old previously received messages need to be deleted to free up some memory allowing one or more new messages to be received.

12. The method of claim 7, further comprising at the message server, for each message of the plurality of messages:
determining whether the information in the message exceeds the display capabilities of a recipient display device having the device identifier associated with the selected identifier to which the message was addressed;
if the information in the message does not exceed the display capabilities of the recipient display device, providing the message from the message server to the recipient display device; and
if the information in the message does exceed the display capabilities of the recipient display device, providing only a portion of the message that does not exceed the display capabilities of the recipient display device.

13. The method of claim 7, further comprising at the message server, for each message of the plurality of messages:
determining whether the information in the message exceeds the display capabilities of a recipient display device having the device identifier associated with the selected identifier to which the message was addressed;
if the information in the message does not exceed the display capabilities of the recipient display device, providing the message from the message server to the recipient display device; and
if the information in the message does exceed the display capabilities of the recipient display device, alerting the sender of the message that the message exceeds the display capabilities of the recipient display device.

14. The method of claim 13, further comprising if the sender has been alerted that the message exceeds the display capabilities of the recipient display device, allowing the sender to modify the message so that the modified message does not exceed the display capabilities of the recipient display device.

15. A persistence of vision display device configured to use an oscillating wand having an array of discrete light sources to display information, the device comprising:
a memory storing computer-executable instructions;
a network interface couplable to a network and configured to download at least one message from a remote computer over the network, the at least one message comprising information for display by the device; and
a processor coupled to the memory and the array of discrete light sources, the processor being operable to execute the computer-executable instructions stored in the memory and to turn selected ones of the discrete light sources on and off, the computer-executable instructions including instructions for instructing the processor to turn selected ones of the discrete light sources on and off at appropriate times as the wand oscillates to display the information of the at least one message received from the remote computer.

16. The device of claim 15, wherein:
the memory stores a data structure configured to store messages;
the at least one message is stored in the data structure; and
the computer-executable instructions include instructions for instructing the processor to obtain the information of the at least one message received from the remote computer from the data structure.

17. The device of claim 15, wherein:
the network interface is configured to send a query to the remote computer querying whether a new messages is available;
and if a new message is available, the network interface is configured to download the at least one message from the remote computer over the network.

18. The device of claim 15 for use by a user, wherein:
the memory stores a first data structure configured to store received messages and a second data structure configured to store local messages, each local message including information for display by the device using the array of discrete light sources of the wand, the second data structure storing at least one local message,
the at least one message received from the remote computer is stored in the first data structure; and
the computer-executable instructions include:
instructions for instructing the processor to obtain the information of the at least one message received from the remote computer from the first data structure,
instructions for instructing the processor to obtain the information of the at least one local message from the second data structure, and
instructions for instructing the processor to turn selected ones of the discrete light sources on and off at appropriate times as the wand oscillates to display the information of the at least one local message,
the device further comprising, a user interface configured to allow the user to select whether the processor executes the instructions for obtaining the information of the at least one message received from the remote computer from the first data structure and displaying the information of the at least one message received from the remote computer, or the instructions for obtaining the information of the at least one local message from the second data structure and displaying the information of the at least one local message.

19. A system for displaying messages to a user comprising:
a persistence of vision display device couplable to a network and configured to download messages therefrom including information for display by the persistence of vision display device, the persistence of vision display device being configured to display the information; and
a message server coupled to the network and configured to receive messages for the persistence of vision display device from a plurality of computing devices over the network and to respond to download requests for those messages from the persistence of vision display device.

20. The system of claim 19, wherein the persistence of vision display device is configured to send a download request periodically to the message server over the network requesting any messages received thereby for the persistence of vision display device, and
the message server is configured to respond to the download requests for any messages received for the persistence of vision display device in response to receiving the request.

21. The system of claim 20, wherein the persistence of vision display device further comprises a device identifier, the request comprises the device identifier, and the message server is further configured to use the device identifier to identify the persistence of vision display device and download messages received for the persistence of vision display device thereto.

22. A method of communicating information to a user for display by a persistence of vision display device coupled to a network, the method comprising:
providing a message server configured to receive a message from a sender over the network that includes information for display by the persistence of vision display device;
receiving at the message server, a request from the persistence of vision display device for the message;
in response to receiving the request, downloading the message from the message server to the persistence of vision display device; and
at the persistence of vision display device, displaying the information to the user by the persistence of vision display device.

23. The method of claim 22, wherein the persistence of vision display device has a device identifier, the message server has the device identifier for the persistence of vision display device, the message includes the device identifier, and downloading the message from the message server to the persistence of vision display device comprises using the device identifier to associate the message with the persistence of vision display device.

24. The method of claim 22, wherein the sender provides the message received by the message server by:
going to the message server over the network,
providing an account identifier associated with the device identifier to the message server,
entering the information included in the message, and
instructing the messaging server to send the message to the persistence of vision display device.

25. The method of claim 22, wherein the message server sends the message to the persistence of vision display device and a capacity indicator indicating whether the message server has reached a limit of the number of messages that the message server can receive indicating old previously received messages need to be deleted to free up some memory on the message server, before old messages are deleted, the message server does not receive one or more new messages.

26. The method of claim 22, further comprising:
at the message server, determining whether the information in the message exceeds the display capabilities of the persistence of vision display device.

27. The method of claim 22, further comprising:
at the message server, determining whether the information in the message exceeds the display capabilities of the persistence of vision display device; and
if the information in the message does not exceed the display capabilities of the persistence of vision display device, sending the message from the message server to the persistence of vision display device; and if the information in the message does exceed the display capabilities of the persistence of vision display device, alerting the sender of the message that the message exceeds the display capabilities of the persistence of vision display device.

28. The method of claim 27, further comprising allowing the sender to modify the message so that the modified message does not exceed the display capabilities of the persistence of vision display device.

29. A method of communicating information to a plurality of persistence of vision display devices coupled to a network, the method comprising:
providing a message server configured to receive messages including information for display by one or more of a plurality of persistence of vision display devices to a message server;
receiving at the message server, a request for a message from each persistence of vision display device in a portion of the plurality of the persistence of vision display devices;
for each request received at the message server, the message server providing at least one of the messages received by the message server for display by the persistence of vision display device thereto; and
at each of the persistence of vision display devices that receives at least one message received by the message server, displaying the information included in the received message.

30. The method of claim 29, wherein each of the one or more of a plurality of persistence of vision display devices has a device identifier,
each of the messages received by the message server includes an account identifier associated with at least one the plurality of persistence of vision display devices, and
for each request received at the message server, the message server sending at least one of the messages received by the message server for display by the persistence of vision display device comprises using the account identifier in the at least one of the messages to associate the at least one of the messages with the persistence of vision display device.

31. A method of communicating a plurality of messages each including information for display by a persistence of vision display device coupled to a network, the method comprising:
receiving the plurality of messages;
selecting messages from the plurality of messages for the persistence of vision display device to download;
receiving a notification that the persistence of vision display device is available to receive messages;
providing the selected messages to the persistence of vision display device; and
at the persistence of vision display device, displaying the information in the selected messages.

32. A method of communicating information to a user for display by a display device coupled to a network, the method comprising:
providing a message server configured to receive a message from a sender over the network that includes information for display by the display device;
receiving at the message server, a request from the display device for the message;
in response to receiving the request, downloading the message from the message server to the display device; and
at the display device, displaying the information to the user by the display device.

33. The method of claim 32, wherein the display device has a device identifier, the message server has the device identifier for the display device, the message includes the device identifier, and downloading the message from the message server to the display device comprises using the device identifier to associate the message with the display device.

34. The method of claim 32, wherein the sender provides the message received by the message server by:
going to the message server over the network,
providing an account identifier associated with the device identifier to the message server,
entering the information included in the message, and
instructing the messaging server to send the message to the display device.
